(19) United States
(12) Patent Application Publication
(10) Pub. No.: US 2014/0278719 A1
(43) Pub. Date: Sep. 18, 2014

(54) ESTIMATING REQUIRED TIME FOR PROCESS GRANULARIZATION

(71) Applicant: International Business Machines Corporation, Armonk, NY (US)

(72) Inventors: FLORIAN PINEL, New York, NY (US); Krishna C. Ratakonda, Yorktown Heights, NY (US); Lav R. Varshney, Yorktown Heights, NY (US)

(73) Assignee: International Business Machines Corporation, Armonk, NY (US)

(21) Appl. No.: 13/970,063

(22) Filed: Aug. 19, 2013

Related U.S. Application Data
(63) Continuation of application No. 13/834,937, filed on Mar. 15, 2013.

(51) Int. Cl. G06Q 10/06

(52) U.S. Cl. CPC G06Q 10/06316
USPC 705/7.26

(57) ABSTRACT

Estimating a time required to complete an atomic task, where the atomic task is one of a plurality of atomic tasks that collectively forms a molecular task, includes obtaining, for each of a plurality of molecular tasks including the molecular task, data including: a known time required to complete each of the plurality of molecular tasks and a known list of constituent atomic tasks forming each of the plurality of molecular tasks, and estimating the time required to complete the atomic task based on the data.

### BACKGROUND OF THE INVENTION

This application is a continuation of U.S. patent application Ser. No. 13/834,937, filed Mar. 15, 2013, which is herein incorporated by reference in its entirety.

### BACKGROUND OF THE INVENTION

The present invention relates generally to project management and relates more specifically to the generation of work breakdown structures for use in project management.

A work breakdown structure (WBS), in project management, is a deliverable-oriented decomposition of a project into smaller components. It defines and groups a project's discrete work elements or tasks in a way that helps organize and define the total work scope of the project. For instance, a WBS may include estimates of the time (i.e., duration and/or effort) required to complete each of the tasks; these estimates may, in turn, be used to plan the schedules and assignments of work to workers in complicated service delivery settings.

Optimal planning and work orchestration often requires estimates of the time of various atomic tasks. Unfortunately, such estimates are often unavailable; instead, only estimates for larger molecular tasks are available (e.g., in service catalogs). Thus, the estimates are not available at the optimal level of granularity. As a simple example, consider a recipe whose directions include three steps. The recipe may specify an estimated preparation time of ten minutes, but it may not specifically identify how those ten minutes are consumed by the three steps (e.g., step one takes five minutes, step two takes three minutes, and step three takes two minutes).

### SUMMARY OF THE INVENTION

Estimating a time required to complete an atomic task, where the atomic task is one of a plurality of atomic tasks that collectively forms a molecular task, includes obtaining, for each of a plurality of molecular tasks including the molecular task, data including: a known time required to complete each of the plurality of molecular tasks and a known list of constituent atomic tasks forming each of the plurality of molecular tasks, and estimating the time required to complete the atomic task based on the data.

### BRIEF DESCRIPTION OF THE DRAWINGS

So that the manner in which the above recited features of the present invention can be understood in detail, a more particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a directed acyclic graph representing an exemplary work breakdown structure;

FIG. 2 is a flow diagram illustrating one embodiment of a method for estimating time required for project granularization, according to the present invention; and

FIG. 3 is a high-level block diagram of the time estimation method that is implemented using a general purpose computing device.

### DETAILED DESCRIPTION

In one embodiment, the invention is a method and apparatus for estimating required time (i.e., duration and/or effort) for project granularization. In particular, embodiments of the invention estimate the time of atomic tasks or work elements from a database that specifies the combined estimated time for molecular tasks including the atomic tasks. Although the present invention is generally discussed within the context of estimating the “time” required to complete a task, it will be appreciated that the term “time” is used to refer not just to the literal duration of a task, but also or alternatively to the level of effort required to complete the task. Moreover, the same approach that is used to estimate the time required could also be used to estimate any other quantitative, additive property of the atoms (e.g., cost or the like).

Within the context of the present invention, an “atom” or “atomic” task or work element is a task that cannot be broken into smaller constituent tasks (i.e., an indivisible task). A “molecule” or “molecular” task or work element is a structured collection of atomic tasks that are linked together as a larger task. An “equivalence class” of atoms is a set of atomic tasks that are considered to require approximately the same amount of time to complete (e.g., within some tolerance). A “molecule catalog” is a predefined list of all possible molecules, their constituent atoms, and the estimated time required to complete the molecules. An “incomplete” atom catalog is a predefined list of all possible atoms and the molecules that contain them. A “complete” atom catalog is a predefined list of all possible atoms and the estimated time required to complete the atoms.

Embodiments of the invention represent a WBS as a directed acyclic graph. FIG. 1, for example, is a directed acyclic graph 100 representing an exemplary work breakdown structure. As illustrated, the nodes of the graph represent the discrete tasks of a project and the estimated durations of the tasks, while the edges indicate an order in which the tasks should be performed and a maximum time that may elapse between connected tasks.

Thus, three basic pieces of information are required in order to construct a WBS: (1) a partial ordering of nodes (i.e., which tasks follow with other tasks); (2) edge labels; and (3) node labels. The partial ordering of nodes can be determined from the input/output relationships of the steps of a workflow. The edge labels indicate the maximum amount of time that may elapse between tasks connected by the edges (e.g., between zero and infinity). The node labels indicate estimated time required for the tasks represented by the nodes. For some tasks, the estimated time required may be obtained from the original data source from which the workflow is obtained. For other tasks, however, the estimated time required, though present in the original data source, may be imprecise (for example, it may be combined into the total estimated time required for a larger workflow, as in the case of the recipe discussed above).

FIG. 2 is a flow diagram illustrating one embodiment of a method 200 for estimating time required for project granularization, according to the present invention. The invention may be implemented, for example, by a processor that is used to plan the schedules and assignments of work to workers for a given project. As such, reference is made to a processor in the discussion of the method 200. However, it will be appreciated that other devices and systems may implement the method 200 for the same purposes.

The method 200 begins in step 202. In step 204, the processor obtains a molecule catalog. As discussed above, the molecule catalog is a predefined list of all possible molecules, the constituent atoms of the molecules, and the estimated time required to complete the molecules.

In step 206, the processor breaks or divides each molecule in the molecule catalog into a corresponding list of constituent atoms, according to the molecule catalog. This results in the creation of an incomplete atom catalog, i.e., a predefined list or pool of all possible atoms and the molecules that contain them.

In step 208, the processor categorizes the incomplete catalog into a plurality of equivalence classes. That is, the processor clusters all of the atoms from the disparate molecules into sets, where all of the atoms in a given set are considered to require the same amount of time to complete. Thus, labels indicating the resultant equivalence classes may be incorporated into the incomplete atom catalog. As an example, the atoms “chop onion and place in medium bowl;” “chop one medium onion;” and “chop one red onion” may all be grouped into an equivalence class of “chop onion,” while the atoms “cut apples into one inch squares” and “cube apples with a sharp knife” may both be grouped into an equivalence class of “cube apples.” Equivalence classes are not limited to steps that operate on single objects, however. For instance, the atoms “fold wet ingredients into flour mixture;” “combine buttermilk, eggs, and flour;” “make well in dry ingredients, pour wet ingredients into well, and mix;” and “pour wet ingredients into dry ingredients and mix until just combined” can all be grouped into an equivalence class of “mix wet and dry ingredients.” Thus, there are various measures of similarity (e.g., use of similar objects or operations, among other measures) that may be used to group atoms.

In one embodiment, clustering of the atoms into equivalence classes is performed using a computer-implemented, unsupervised clustering technique (e.g., based on features from an atom ontology, on a notion of text similarity, or on a metrization of atom space). When forming the equivalence classes, there is a tradeoff between the estimated poorness of the inverse problem solution that is obtainable (denoted as κ) and the internal coherence of the equivalence classes (denoted as σ). κ and σ must be balanced to obtain the best overall performance of the method 200. One way to approach to balancing κ and σ is to use an iterative, hierarchical approach to form the equivalence classes. In this case, a hierarchy is defined for the equivalence classes (e.g., using tree-structured, k-means clustering). As an example, the hierarchy can be defined jointly in the simple examples discussed above by both ingredient (e.g., red onion<onion<bulb<produce) and action (e.g., brunoise<dice<cut). Once the hierarchy is established, one can proceed up the hierarchy, decreasing σ until κ is sufficiently small (e.g., satisfies a threshold).

In optional step 210 (illustrated in phantom), the processor quantifies the constituents of the equivalence classes. For instance, the two constituents of the equivalence class “chop onion” might be individually quantified as “chop onion—150 grams” and “chop onion—200 grams,” based on their original listings in the molecule catalog.

In step 212, the processor normalizes the atoms within the equivalence classes, in order to account for disparities. For instance, if the atoms in a given equivalence class are of different weights, measures, sizes, or complexities, or if the atoms are processed using different tools or instruments, the values or characteristics of these atoms may be adjusted to a notionally common scale. In one embodiment, normalization involves weighting the individual atoms in a given equivalence class to achieve the common scale. For instance, in the above example “chop onion—150 grams” and “chop onion—200 grams” may be weighted by 1.67 and 1.25, respectively.

In step 214, the processor constructs a measurement operator from the atom/molecule relationships (i.e., the indications as to which atoms are part of which molecules) and a measurement vector from the time required to complete each molecule (according to the molecule catalog).

In step 216, the processor calculates, in accordance with the measurement operator and measurement vector, the time required to complete each of the atoms. This results in the creation of a complete atom catalog (i.e., a predefined list of all possible atoms and the estimated time required to complete the atoms). In one embodiment, the times required are calculated using an inference technique that uses the measurement operator and measurement vector as inputs to solve an inverse problem. In one embodiment, the inverse problem can be stated as:

\vec{y}=A(\vec{x}+\vec{η})+\vec{ε} (EQN. 1)

where A is a nonlinear operator (which may be a matrix multiplication in the simplest case), and \vec{η} and \vec{ε} are noise vectors (which may be all-zero vectors in the simplest case.

In one embodiment, the inference technique employs a linear algebra formulation. The time required to complete a task is an extensive quantity and essentially sums linearly (excluding possible work synergies). Thus, one can assume that:

y=xₐ+x_{b}+x_{c} (EQN. 2)

where y is the total time required to complete a given molecular task, and xₐ, x_{b}, and x_{c} are the individual times required for three atomic tasks a, b, and c that make up the molecular task. Further assuming that there is a finite set of possible steps from which the steps of a given work breakdown structure are chosen, indicator variables aᵢ=1 can be used to write a generalized expression for the sum, where aᵢ=0 for absent steps and aᵢ=1 for present steps. For instance, in:

$$[ \begin{matrix}{a}_{1} & {a}_{2} & {a}_{3} & {a}_{4} & {a}_{5} & {a}_{6}\end{matrix} ] [ \begin{matrix}{x}_{1} \\ {x}_{2} \\ {x}_{3} \\ {x}_{4} \\ {x}_{5} \\ {x}_{6}\end{matrix} ] = y \qquad ( EQN . 3 )$$

y and a₁-a₆ are known, whereas x₁-x₆ are unknown. Because there are more equations than unknowns, the inverse problem is incomplete (or undercomplete). However, if on considers a service catalog including a plurality M of work breakdown structures M and plurality N of potential steps, EQN. 3 becomes

$$[ \begin{matrix}{a}_{11} & … & {a}_{1 N} \\ ⋮ & ⋱ & ⋮ \\ {a}_{M 1} & … & {a}_{MN}\end{matrix} ] [ \begin{matrix}{x}_{1} \\ ⋮ \\ {x}_{N}\end{matrix} ] = [ \begin{matrix}{y}_{1} \\ ⋮ \\ {y}_{M}\end{matrix} ] \qquad ( EQN . 4 )$$

where A is a sparse binary matrix. Thus, the inference problem becomes solving A\vec{x}=\vec{y} for \vec{x}.

Depending on the specific nature of A, any one or more of a plurality of nonlinear inference algorithms may be implemented (e.g., by the processor) to solve the inverse problem. For instance, in one embodiment, the Lanczos inverse, is used for a linear approximation. In this case, the inverse problem becomes:

\vec{x}=(A^{T}A)⁻¹A^{T}\vec{y} (EQN. 5)

Using a computer-implementable technique to solve the inverse problem may be advantageous when the available data may be inaccurate, insufficient, and/or inconsistent. Another linear approximation technique that may be used to solve the inverse problem involves using message-passing Bayesian inference, such as is used for compressed sensing coding. Bayesian inference of this type may be advantageous when there is some prior knowledge of the statistical nature of \vec{x}.

In a further embodiment, where the times associated with each of the atoms are assumed to be stochastic quantities governed by a probability measure, Xᵢ(ω) (rather than assumed to have precise or fixed times xᵢ), the inverse problem expressed by EQN. 1 may be restated as:

\vec{y}=A(\vec{x}+\vec{η})+\vec{ε} (EQN. 6)

where \vec{X} is a vector of scalar probability measures. In this case, the inverse problem may be solved, for example, using Bayesian inference.

In step 218, the processor outputs (e.g., via an output device such as a display or a network interface) the complete atom catalog. The method 200 then ends in step 220.

In one embodiment, the measurement operator may be tested prior to step 216 in order to determine whether the measurement operator is sufficiently invertible (e.g., satisfies a threshold). If the measurement operator is not sufficiently invertible, steps 208-214 may be repeated at least one, using coarser equivalence classes, until a sufficiently invertible measurement operator can be constructed.

The method 200 therefore estimates unknown time required to perform granularized atomic tasks, based on the known time required to complete molecular tasks and the known memberships of atoms in molecules. By grouping the atomic tasks into equivalence classes whose members are treated as requiring the same amount of time to complete, one can substantially ensure that the inverse problem to be solved is not incomplete.

The complete atom catalog produced by the method 200 can be used to improve the granularization of work tasks, so as to enable finer and better project planning in complex work systems (e.g., for knowledge work in global service delivery, for factory work for manufacturing, for fine encapsulation for the crowdsourcing of work, for cooking under tight time and resource constraints, or other tasks). By enabling greater efficiency in down-stream planning and management, better utilization and tighter schedules (and, therefore, potential cost savings) can be achieved.

As discussed in connection with step 212 of the method 200, the atoms of the disparate molecules may be normalized to account for discrepancies in weights, measures, sizes, complexities, or tools or instruments used in processing. One way to implement this normalization (in the linear setting) is to weight the “A” matrix of EQN. 3 with weights associated with the atoms (e.g., “chop three medium onions” becomes “‘chop onions’ times three”), rather than implement the matrix as a binary matrix. In a further embodiment, the subsequent grouping into equivalence classes is done in a way that substantially ensures that the “A” matrix is not diagonal.

FIG. 3 is a high-level block diagram of the time estimation method that is implemented using a general purpose computing device 300. In one embodiment, a general purpose computing device 300 comprises a processor 302, a memory 304, a time estimation module 305 and various input/output (I/O) devices 306 such as a display, a keyboard, a mouse, a stylus, a wireless network access card, an Ethernet interface, and the like. In one embodiment, at least one I/O device is a storage device (e.g., a disk drive, an optical disk drive, a floppy disk drive). It should be understood that the time estimation module 305 can be implemented as a physical device or subsystem that is coupled to a processor through a communication channel.

Alternatively, the time estimation module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the time estimation module 305 for estimating required time (i.e., duration and/or effort) for project granularization, as described herein with reference to the preceding figures, can be stored on a tangible (e.g., non-transitory) computer readable storage medium (e.g., RAM, magnetic or optical drive or diskette, and the like).

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A system for estimating a time required to complete an atomic task, wherein the atomic task is one of a plurality of atomic tasks that collectively forms a molecular task, the system comprising:
a processor; and
a computer readable storage medium that stores instructions which, when executed, cause the processor to perform operations comprising:
obtaining, for each of a plurality of molecular tasks including the molecular task, data including: a known time required to complete the each of the plurality of molecular tasks and a known list of constituent atomic tasks forming the each of the plurality of molecular tasks; and
estimating the time required to complete the atomic task based on the data.

2. The system of claim 1, wherein the data is obtained from a database.

3. The system of claim 1, wherein the known time required to complete the each of the plurality of molecular tasks is stated in terms of a level of effort.

4. The system of claim 1, wherein the known time required to complete the each of the plurality of molecular tasks is stated in terms of duration.

5. The system of claim 1, wherein the estimating comprises:
generating a pool of atomic tasks comprising the constituent atomic tasks associated with each of the plurality of molecular tasks;
grouping the pool of atomic tasks into a first plurality of clusters, wherein each of cluster in the first plurality of clusters includes a set of atomic tasks from the pool of atomic tasks that are considered to require an approximately equivalent amount of time to complete; and
forming an inverse problem in accordance with the first plurality of clusters, wherein a solution to the inverse problem is an estimate of the time required to complete the atomic task.

6. The system of claim 5, wherein the grouping is based on a measure of similarity that relates the set of atomic tasks.

7. The system of claim 6, wherein the measure of similarity is a use of a similar object.

8. The system of claim 6, wherein the measure of similarity is a use of a similar operation.

9. The system of claim 6, wherein the grouping is performed using an unsupervised clustering technique.

10. The system of claim 9, wherein the unsupervised clustering technique is based on features from an atom ontology.

11. The system of claim 9, wherein the unsupervised clustering technique is based on a notion of text similarity.

12. The system of claim 9, wherein the unsupervised clustering technique is based on a metrization of atom space.

13. The system of claim 5, wherein the grouping balances an estimated poorness of the solution against an internal coherence of the first plurality of clusters.

14. The system of claim 13, wherein the grouping is performed using an iterative, hierarchical technique.

15. The system of claim 14, wherein the iterative hierarchical technique comprises:
defining a hierarchy for the first plurality of clusters; and
decreasing the internal coherence of the plurality of clusters by proceeding up the hierarchy, until the estimated poorness of the solution satisfies a threshold.

16. The system of claim 5, wherein the estimating further comprises:
normalizing the set of atomic tasks in each of the first plurality of clusters, prior to the forming.

17. The system of claim 16, wherein the estimating further comprises:
quantifying the set of atomic tasks in each of the first plurality of clusters, prior to the normalizing.

18. The system of claim 5, wherein the forming comprises:
constructing a measurement operator from relationships between the each of the plurality of molecular tasks and the constituent atomic tasks; and
constructing a measurement vector from the known time required to complete the each of the plurality of molecular tasks,
wherein the measurement operator and the measurement vector are inputs to the inverse problem.

19. The system of claim 18, wherein the forming further comprises
confirming that the measurement operator is invertible enough to satisfy a threshold, prior to using the measurement operator as an input to the inverse problem.

20. The system of claim 19, wherein the forming further comprises, when the measurement operator is not invertible enough to satisfy the threshold:
re-grouping the pool of atomic tasks into a second plurality of clusters that is coarser than the first plurality of clusters; and
re-constructing the measurement operator subsequent to the re-grouping.
